(19) United States
(12) Patent Application Publication
(10) Pub. No.: US 2025/0113198 A1
(43) Pub. Date: Apr. 3, 2025

(54) LOCATION BASED TRANSMITTING OF DATA TO AN EXTERNAL CONTENT PRESENTATION DEVICE

(71) Applicant: Motorola Mobility LLC, Chicago, IL (US)

(72) Inventors: Amit Kumar Agrawal, Bangalore (IN); Ranjeet Gupta, Naperville, IL (US)

(73) Assignee: Motorola Mobility LLC, Chicago, IL (US)

(21) Appl. No.: 18/374,936

(22) Filed: Sep. 29, 2023

(51) Int. Cl. H04W 12/63; H04L 67/01; H04W 4/02; H04W 4/021

(52) U.S. Cl. CPC H04W 12/63; H04L 67/01; H04W 4/021; H04W 4/023

(57) ABSTRACT

A mobile device operates as an intermediary between a remote electronic device and an external content presentation device. A cloud computing device executes on the remote electronic device and a cloud computer interface is transmitted (e.g., streamed) to the external content presentation device via the mobile device. The location of the mobile device is monitored and if the mobile device is moved at least a threshold amount (e.g., away from an initial location of the mobile device or the external content presentation device), the mobile device locks the cloud computing device, such as by ceasing transmitting the cloud computer interface to the external content presentation device and ceasing receiving (e.g., ignores or deletes) inputs from the external input devices.

### BACKGROUND

As technology has advanced, our uses for electronic devices have expanded. One such use is small mobile devices, such as smartphones, which have become increasingly powerful despite their small size. These mobile devices provide a great deal of portable processing power but are not without their problems. One such problem is that situations arise in which users desire to connect their mobile devices to other electronic devices, such as external monitors. This can result in security issues for a mobile device in trying to control access to information being transferred from the mobile device to the other electronic device.

### BRIEF DESCRIPTION OF THE DRAWINGS

Embodiments of location based transmitting of data to an external content presentation device are described with reference to the following drawings. The same numbers are used throughout the drawings to reference like features and components:

FIG. 1 illustrates an example system implementing the techniques discussed herein;

FIG. 2 illustrates an example system implementing the techniques discussed herein;

FIGS. 3 and 4 illustrate examples implementing the techniques discussed herein:

FIG. 5 illustrates an example process for implementing the techniques discussed herein in accordance with one or more embodiments:

FIG. 6 illustrates another example process for implementing the techniques discussed herein in accordance with one or more embodiments:

FIG. 7 illustrates various components of an example electronic device that can implement embodiments of the techniques discussed herein.

### DETAILED DESCRIPTION

Location based transmitting of data to an external content presentation device is discussed herein. Generally, a mobile device, such as a smartphone, connects to or is coupled to an external content presentation device and optionally one or more external input devices (e.g., a keyboard, a mouse, a trackpad). The connection or coupling can be a wired or wireless connection or coupling. The mobile device also communicates with a remote electronic device that runs a cloud computing device for a user of the electronic device, such as a virtual machine. The remote electronic device transmits (e.g., streams) a computing device interface to the mobile device, which in turn transmits (e.g., streams) the computing device interface to the external content presentation device. User inputs provided via the external input devices are received by the mobile device and transmitted to the remote electronic device, which provides the inputs to the cloud computing device.

Thus, the mobile device operates as an intermediary between the remote electronic device and the external content presentation device. The cloud computing device executes on the remote electronic device and the cloud computer interface (e.g., a user interface) is transmitted (e.g., streamed) to the external content presentation device via the mobile device. This allows the user of the external content presentation device to run various programs on the cloud computing device as if the programs were run on the external content presentation device itself.

Situations can arise in which the mobile device is moved away from the external content presentation device yet remains connected to the external content presentation device. Using the techniques discussed herein, the location of the mobile device is monitored and if the mobile device is moved at least a threshold amount, the mobile device locks the cloud computing device. This locking can be performed in various manners, such as ceasing transmitting the cloud computer interface to the external content presentation device and ceasing receiving (e.g., ignoring or deleting) inputs from the external input devices, locking the external content presentation device and external input device (e.g., turning off the external content presentation device (e.g., displaying a black screen), transmitting a final blank or empty image for display on the external content presentation device, ignoring or deleting any inputs from the external input devices, etc.), combinations thereof, and so forth. This prevents another user from using the external content presentation device and external input devices to interact with the cloud computing device when the owner steps away from the external content presentation device with the mobile device.

For example, assume the mobile device is a smartphone and the owner of the smartphone is using a cloud computing device of the remote electronic device to run a program such as a spreadsheet program, and the user interface of the cloud computing device that is displayed on the external content presentation device includes a user interface of the spreadsheet program. Further assume that the owner of the smartphone receives a phone call on the smartphone and steps away from the external content presentation device to answer the phone call. In response to the mobile device moving a threshold amount (e.g., at least a threshold distance from the external content presentation device), the mobile device locks the cloud computing device, e.g., by ceasing transmitting the cloud computer interface to the external content presentation device and ceasing receiving (e.g., ignores) any inputs from the external input devices, thereby preventing the user from interacting with the spreadsheet program.

The techniques discussed herein improve the operation of a mobile device by providing security when the mobile device is using an external content presentation device and the mobile device is moved away from the external content presentation device. By locking the cloud computing device, when the mobile device is moved a threshold amount (e.g., away from the external content presentation device) an unintended user (e.g., a malicious user) is unable to access the cloud computing device or cloud computing device interface being streamed from the remote electronic device to the external content presentation device via the mobile device. E.g., a blank screen is displayed on the external content presentation device rather than the cloud computer interface, any input to the external input devices is ignored or not received by the mobile device, and so forth.

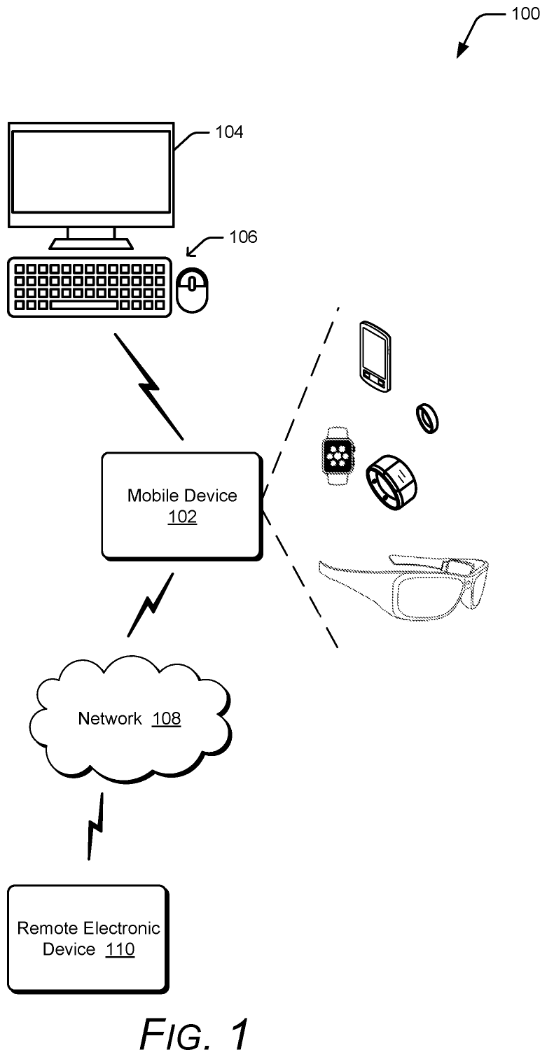

FIG. 1 illustrates an example system 100 implementing the techniques discussed herein. The system 100 includes a mobile device 102, an external content presentation device 104, an external input device 106, a network 108, and a remote electronic device 110. The mobile device 102 can be, or include, many different types of computing or electronic devices. For example, the mobile device 102 can be a smartphone or other wireless phone, a tablet computer, or a phablet computer. By way of further example, the mobile device 102 can be a notebook computer (e.g., netbook or ultrabook), a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device), and so forth. The mobile device 102 is typically designed to be readily and easily moveable by a user and thus is referred to as a mobile device.

The mobile device 102 is connected to or coupled to the external content presentation device 104 and the external input device 106. Multiple external input devices 106 are illustrated as a keyboard and a mouse but an external input device 106 can be any of a variety of input devices, such as a trackpad or other cursor control (or pointer control) device, a microphone, and so forth. Although illustrated as separate from the external content presentation device 104, in one or more implementations the external input device 106 is part of the external content presentation device 104. The external input device 106 is associated with and allows a user of the external content presentation device 104 to interact with a user interface displayed on the external content presentation device 104.

It should be noted that in one or more implementations the external content presentation device 104 simply displays data received form the mobile device 102. The external content presentation device 104 need not, and typically does not perform any processing of input information but simply displays what is provided to the external content presentation device 104 by the mobile device 102. Accordingly, the external content presentation device 104 may also be referred to as a dumb terminal or dumb device.

The mobile device 102 communicates with the external content presentation device 104 and the one or more external input device 106 using a wired or wireless connection. Any of a variety of connection or communication techniques or protocols can be used, such as Universal Serial Bus (USB), USB-C, IEEE 1394, High-Definition Multimedia Interface (HDMI)), DisplayPort, Wi-Fi, Bluetooth, infrared (IR), and so forth. The mobile device 102 communicates with the external content presentation device 104 and the external input device 106 using a wired or wireless connection.

In one or more implementations, each of the external content presentation device 104 and the external input device 106 is connected or coupled to the mobile device 102 using any of the connection or communication techniques or protocols discussed above. Additionally or alternatively, the external input device 106 is connected or coupled to the external content presentation device 104 and communicates with the mobile device 102 through the external content presentation device 104. Additionally or alternatively, the external content presentation device 104 is connected or coupled to the external input device 106 and communicates with the mobile device 102 through the external input device 106. Although a single external content presentation device 104 is illustrated in FIG. 1, it is to be appreciated that multiple external content presentation devices 104 can be coupled or connected to the mobile device 102.

The mobile device 102 also communicates with the remote electronic device 110 via the network 108. The network 108 can be any of a variety of different networks, such as the Internet, a local area network (LAN), a public telephone network, a cellular network (e.g., a third generation (3G) network, a fourth generation (4G) network, a fifth generation (5G) network), an intranet, other public or proprietary networks, combinations thereof, and so forth.

The remote electronic device 110 provides a cloud computing device to the external content presentation device 104 and external input device 106 via the mobile device 102. In one or more implementations, the cloud computing device is a virtual device (e.g., a virtual machine) hosted by the remote electronic device 110. Additionally or alternatively, the remote electronic device 110 is itself the cloud computing device.

The cloud computing device generates a computing device interface (e.g., a user interface) and transmits the computing device interface to the mobile device 102. The mobile device 102 transmits the computing device interface to the external content presentation device 104 for display. Any user inputs to the computing device interface received by an external input device 106 are transmitted to the mobile device 102, which transmits the user inputs to the cloud computing device.

Accordingly, the mobile electronic device 102 operates as an intermediary between the remote electronic device 110 (that is running or that is the cloud computing device) and the external content presentation device 104. This allows the mobile device 102 to support a user of the external content presentation device 104 running various programs on the cloud computing device as if the programs were run on the external content presentation device 104 itself.

Although discussed herein as a user interface, additionally or alternatively the cloud computing devices transmits other data to the mobile device for transmission to the external content presentation device 104.

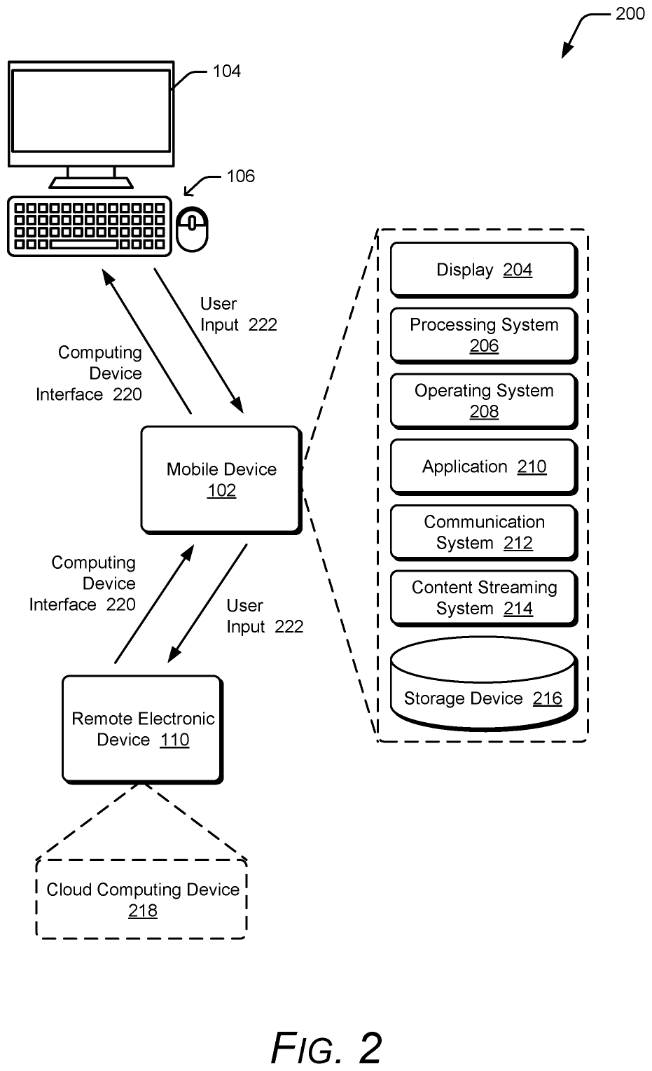

FIG. 2 illustrates an example system 200 implementing the techniques discussed herein. The system 200 illustrates an example of the system 100 of FIG. 1 in additional detail, and includes the mobile device 102, the external content presentation device 104, the external input device 106, and the remote electronic device 110.

The mobile device 102 includes a display 204. The display 204 can be configured as any suitable type of display, such as an OLED display, active matrix OLED display, LCD, in-plane shifting LCD, projector, and so forth. Although illustrated as part of the mobile device 102, it should be noted that the display 204 can be implemented separately from the mobile device 102. The display 204 can also optionally operate as an input device (e.g., the display 204 can be a touchscreen display).

The mobile device 102 also includes a processing system 206 that includes one or more processors, each of which can include one or more cores. The processing system 206 is coupled with, and may implement functionalities of, any other components or modules of the mobile device 102 that are described herein. In one or more embodiments, the processing system 206 includes a single processor having a single core. Alternatively, the processing system 206 includes a single processor having multiple cores or multiple processors (each having one or more cores).

The mobile device 102 also includes an operating system 208. The operating system 208 manages hardware, software, and firmware resources in the mobile device 102. The operating system 208 manages one or more applications 210 running on the mobile device 102, and operates as an interface between applications 210 and hardware components of the mobile device 102.

The mobile device 102 also includes a communication system 212. The communication system 212 manages communication with various other devices, such as by transmitting data and control signals, receiving data and control signals, and so forth. This transmitted or received data can include, for example, a computing device interface (e.g., a user interface for cloud computing device), user input data, and so forth. The communication system 212 can manage communication with the remote electronic device 110 (e.g., via the network 108 of FIG. 1), the external content presentation device 104, the external input device 106, and optionally various other electronic devices.

The mobile device 102 also includes a content streaming system 214. The content streaming system 214 manages the transmission (e.g., streaming) of data and control signals (via the communication system 212) to the external content presentation device 104 and the remote electronic device 110, as well as the receipt of data and control signals from the external content presentation device 104 and the remote electronic device 110. The content streaming system 214 can be implemented in a variety of different manners. For example, the content streaming system 214 can be implemented as multiple instructions stored on computer-readable storage media and that can be executed by the processing system 206. Additionally or alternatively, the content streaming system 214 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The mobile device 102 also includes a storage device 216. The storage device 216 can be implemented using any of a variety of storage technologies, such as magnetic disk, optical disc, Flash or other solid state memory, and so forth. The storage device 216 can store various program instructions and data for any one or more of the operating system 208, application 210, the content streaming system 214, and so forth.

The remote electronic device 110 provides a cloud computing device 218 to the external content presentation device 104 and external input device 106 via the mobile device 102. The cloud computing device 218 can be a virtual device (e.g., a virtual machine) hosted by the remote electronic device 110 or can be the remote electronic device 110 itself as discussed above.

The cloud computing device 218 generates a computing device interface 220 (e.g., a user interface or a cloud computer interface) and transmits the computing device interface to the mobile device 102. The content streaming system 214 of the mobile device 102 receives (via the communication system 212) the computing device interface 220 and transmits (e.g., streams via the communication system 212) the computing device interface 220 to the external content presentation device 104, which displays the computing device interface 220. Any user input 222 (e.g., in response to the computing device interface 220) received by an external input device 106 are transmitted to the mobile device 102. The content streaming system 214 receives (via the communication system 212) the user input 222 and transmits (via the communication system 212) the user input 222 to the cloud computing device 218.

Generally, an initial location of the mobile device 102 is obtained (e.g., determined) when the mobile device 102 is coupled or connected to the external content presentation device 104. The content streaming system 214 determines when the mobile device 102 has moved at least a threshold distance away from the initial location or the external content presentation device 104. In response to determining that the mobile device 102 has moved at least the threshold distance away from the initial location or the external content presentation device 104, the content streaming system 214 locks the cloud computing device 218. Locking the cloud computing device 218 prevents a user of the external content presentation device 104 or the external input device 106 from interacting with the cloud computing device 218. The cloud computing device can be locked in various manners as discussed in more detail below, such as ceasing streaming computing device interface 220 to the external content presentation device 104 and ceasing receiving user input 222 from the external input device 106. If the mobile device 102 subsequently moves back within the threshold distance of the initial location or the external content presentation device 104, the content streaming system 214 resumes streaming computing device interface 220 to the external content presentation device 104 and resumes receiving user input 222 from the external input device 106.

It should be noted that the mobile device 102 may remain connected or coupled to the external content presentation device 104 even though the mobile device 102 has moved at least a threshold distance away from the initial location or the external content presentation device 104.

In one or more implementations, the content streaming system 214 determines an initial location of the mobile device 102. The initial location of the mobile device 102 can be automatically determined in response to various events, such as the mobile device 102 being connected or coupled to the external content presentation device 104. The content streaming system 214 can detect that the mobile device 102 is connected or coupled to the external content presentation device 104 using any of a variety of public or proprietary techniques. For example, the external content presentation device 104 can transmit a signal that is received by the content streaming system 214 indicating that the external content presentation device 104 is connected to the mobile device 102.

A location (e.g., the initial location) of the mobile device 102 refers to one or both of a physical location coordinates (e.g., a latitude, longitude, and altitude) or a relative location (e.g., one or both of a distance or a direction to the external content presentation device 104). The location of the mobile device 102 is determined in any of a variety of different manners.

In one or more implementations, the location of the mobile device 102 is determined using IEEE Wi-Fi round-trip time (RTT) functionality, optionally with fine-time-measurement (FTM) functionality (e.g., compliant with various IEEE 802.11mc standards). Wi-Fi RTT functionality allows wireless devices (e.g., wireless access points) to provide their known location coordinates (e.g., latitude, longitude, and altitude). The mobile device 102 (e.g., communication system 212 or content streaming system 214) can determine the location of the mobile device 102 using the measurements from three or more wireless devices and a multilateration technique (e.g., triangulation).

A communication system of the external content presentation device 104 can similarly use Wi-Fi RTT and optionally FTM to determine the location of the external content presentation device 104. The communication system of the external content presentation device 104 can provide the location to the external content presentation device 104 to the mobile device 102, allowing the mobile device 102 to know the initial location of the mobile device 102 as well as the location of the external content presentation device 104.

It should be noted that the location of a device, such as the mobile device 102 or the external content presentation device 104, can typically be determined using Wi-Fi RTT to a level of accuracy within 1 or 2 meters with a low rate of false or incorrect location determinations. Accordingly, the techniques discussed provide for a more accurate determination of the location of a device than other techniques such as signal strength (e.g., received signal strength indicator (RSSI)) techniques.

Additionally or alternatively, the location of the mobile device 102 is determined using ultra-wideband (UWB) tags. The external content presentation device 104 and the mobile device 102 can both support UWB (e.g., have embedded or attached UWB tags). Signals or pulses emitted by the UWB tab included in or attached to the external content presentation device 104 that include various information (e.g., timestamp) are received by the mobile device 102. Given these signals or pulses, the mobile device 102 can readily determine the distance to and direction of the mobile device 102 relative to the external content presentation device 104. Accordingly, the physical location coordinates (e.g., a latitude, longitude, and altitude) of the mobile device 102 may not be known, but the distance and direction to the external content presentation device 104 is known by the mobile device 102.

After determining the initial location of the mobile device 102, mobile device 102 (e.g., the communication system 212 or the content streaming system 214) determines a subsequent location of the mobile device in response to various events. These events may include, for example, one or more of detecting movement of the mobile device 102 (e.g., based on an accelerometer or gyrometer in the mobile device 102), not receiving user input 222 from the external input device 106 for a threshold amount of time (e.g., 10 or 15 seconds), receiving input from the user input 222 at least than a threshold rate (e.g., fewer than 5 key strokes per minute, fewer than 5 mouse movements per minute), or a regular or irregular interval elapsing (e.g., every 30 or 60 seconds).

Given the subsequent location, the mobile device 102 (e.g., the communication system 212 or content streaming system 214) determines if the mobile device 102 has moved at least a threshold amount away from the initial location. This threshold amount can be determined in a variety of different manners. In one or more implementations, the mobile device 102 determines, given the physical location coordinates (e.g., a latitude, longitude, and altitude) of the initial location and the subsequent location, if the distance between the initial and subsequent locations is greater than a threshold amount (e.g., 10 or 20 feet). If the distance between the initial and subsequent locations is greater than the threshold amount, then the mobile device 102 determines that the mobile device has moved at least the threshold amount away from the initial location.

Additionally or alternatively, the mobile device 102 determines a distance of the mobile device 102 relative to the external content presentation device 104 based on the subsequent location and the location of the external content presentation device 104. If the distance of the mobile device 102 relative to the external content presentation device 104 is greater than a threshold amount (e.g., 12 or 20 feet), then the mobile device 102 determines that the mobile device has moved at least the threshold amount away from the initial location.

The content streaming system 214 locks the cloud computing device in response to detecting that the mobile device 102 has moved at least the threshold amount away from the initially detected location. Locking the cloud computing device refers to one or both of 1) preventing or stopping a user interface of the cloud computing device 218 from being presented on the external content presentation device 104 and 2) preventing or stopping user input to the external input device 106 from being input to or affecting the user interface of the cloud computing device 218.

In one or more implementations, the content streaming system 214 locks the cloud computing device by stopping transmitting data (e.g., the computing device interface 220) to the external content presentation device 104. Accordingly, the data (e.g., the computing device interface 220) is no longer displayed on the external content presentation device 104. The content streaming system 214 also stops receiving data (e.g., user input 222) from the external input device 106, such as by deleting or ignoring any user input 222 sent by the external input device 106, communicating a signal to the external input device 106 to cease sending data (e.g., user input 222), and so forth. In one or more implementations, the content streaming system 214 also notifies the remote electronic device 110 to stop transmitting the data (e.g., computing device interface 220), or ignores (e.g., deletes) the data (e.g., computing device interface 220) received from the remote electronic device 110.

The content streaming system 214 can stop transmitting data (e.g., the computing device interface 220) to the external content presentation device 104 in various manners. For example, the transmission or streaming of data to the external content presentation device 104 may be locked (e.g., the communication system 212 ignores any requests to transmit data to the external content presentation device 104). By way of another example, the mobile device 102 may be disconnected from or uncoupled from the external content presentation device 104, such as by disconnecting or decoupling the mobile device 102 from a wireless local area network that includes the mobile device 102 and the external content presentation device 104. By way of another example, the mobile device 102 may be disconnected from or uncoupled from the mobile device 102 by disabling Wi-Fi Direct on the mobile device 102, disabling an internet service provider (ISP) on Wi-Fi Direct, and so forth.

Locking the cloud computing device 218 may also referred to as securing the external content presentation device 104 (and optionally securing the external input device 106), or securing the cloud computing device 218. Locking the cloud computing device may also be referred to as locking the cloud computer interface or locking the cloud user interface.

Additionally or alternatively, the content streaming system 214 locks the cloud computing device in other manners. For example, the content streaming system 214 may lock the external content presentation device and external input device by turning off the external content presentation device (e.g., displaying a black screen), transmitting a blank or empty image for display on the external content presentation device, ignoring or deleting any inputs from the external input devices, and so forth. By way of another example, the cloud computing device 218 supports a lock application programming interface (API) and an unlock API. The content streaming system 214 invokes the lock API to lock the cloud computing device 218, e.g., ceasing transmitting the computing device interface 220 to the mobile device 102 and ignoring or deleting any user inputs 222 received from the mobile device 102.

It should be noted that locking the cloud computing device or locking the cloud user interface refers to the external content presentation device 104 and the external input device 106 on which the cloud computing device is accessed being locked. The connected display interface (e.g., the external content presentation device 104 and the external input device 106) is locked so that a rogue element does not have access to the cloud computing device through the connected display interface. Accordingly, the connected display interface can be locked and not the cloud server (e.g., the remote electronic device 110) and not the mobile device 102 (e.g., which is presumably with the user and can still be used by the user).

After locking the cloud computing device 218, the mobile device 102 (e.g., the communication system 212 or content streaming system 214) subsequently determines if the mobile device 102 has subsequently moved back within at least a threshold amount from the initially detected location. The location of the mobile device 102 can be determined in various manners analogous to the discussion above regarding determining whether the mobile device 102 has moved at least the threshold amount away from the initial location.

The content streaming system 214 unlocks the cloud computing device 218 in response to detecting that the device has moved to be within the threshold amount from the initially detected location. The content streaming system 214 unlocks the cloud computing device 218 by undoing or reversing operations performed to lock the cloud computing device 218. For example, the content streaming system 214 resumes transmitting the data (e.g., the computing device interface 220) to the external content presentation device 104 and resumes receiving data (e.g., user input 222) from the external input device 106, such as by no longer deleting or ignoring any user input 222 sent by the external input device 106, communicating a signal to the external input device 106 to resume sending data (e.g., user input 222), invokes an unlock API of the cloud computing device 218 in response to which the cloud computing device 218 resumes transmitting the computing device interface 220 to the mobile device 102 and resumes acting on any user inputs 222 received from the mobile device 102, and so forth. In one or more implementations, the content streaming system 214 also notifies the remote electronic device 110 to resume transmitting data (e.g., the computing device interface 220), or ceases ignoring (e.g., deleting) the data (e.g., computing device interface 220) received from the remote electronic device 110.

The threshold amount used to determine if the mobile device 102 has moved back within at least a threshold amount from the initially detected location can is the same threshold amount as was used in determining if the mobile device 102 has moved at least the threshold amount away from the initial location. Additionally or alternatively, the threshold amount used to determine if the mobile device 102 has moved back within at least a threshold amount from the initially detected location can is a different threshold amount than was used in determining if the mobile device 102 has moved at least the threshold amount away from the initial location. Using a different threshold amount (e.g., a smaller threshold amount for determining if the mobile device 102 has moved back within at least a threshold amount from the initially detected location) allows the content streaming system 214 to keep from frequently switching between stopping transmitting the data and resuming transmitting the data when near the edge of the threshold amount.

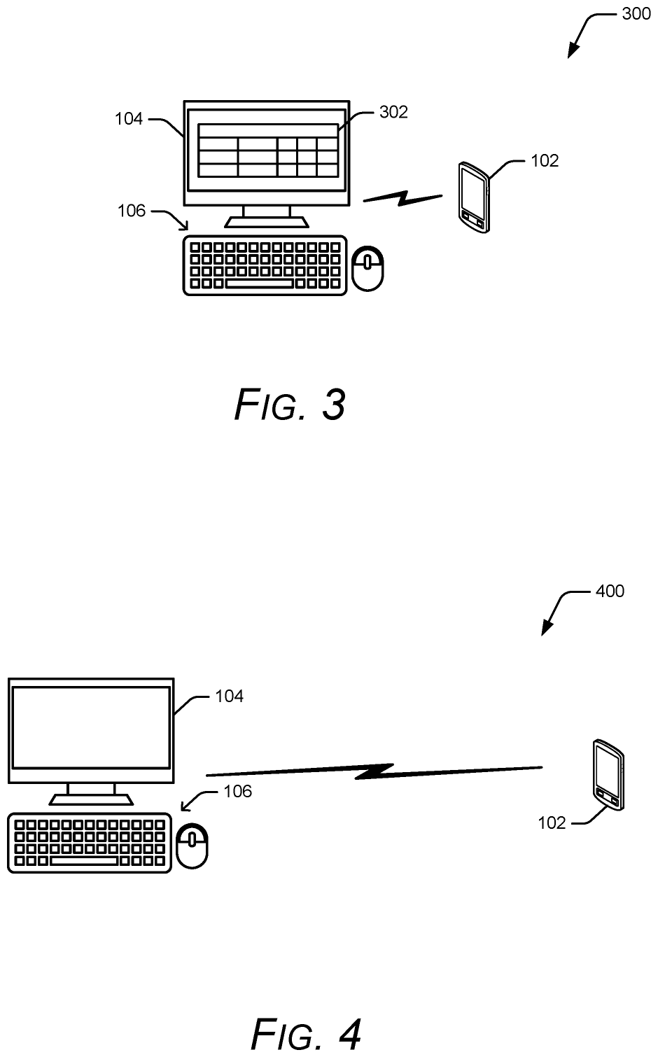

FIGS. 3 and 4 illustrate examples implementing the techniques discussed herein. At 300 in FIG. 3, the mobile device 102, the external content presentation device 104, and the external input device 106 are illustrated. The mobile device 102 is coupled or connected to the external content presentation device 104 and the external input device 106 and is at an initial location. Accordingly, a computing device interface 302 (e.g., showing a spreadsheet) is displayed on the external content presentation device 104.

At 400 in FIG. 4, the mobile device 102, the external content presentation device 104, and the external input device 106 are illustrated. The mobile device 102 is coupled or connected to the external content presentation device 104 and the external input device 106 but is no longer at the initial location and has been moved to a subsequent location that is not within the threshold distance of the initial location. Accordingly, a computing device interface is not displayed on the external content presentation device 104.

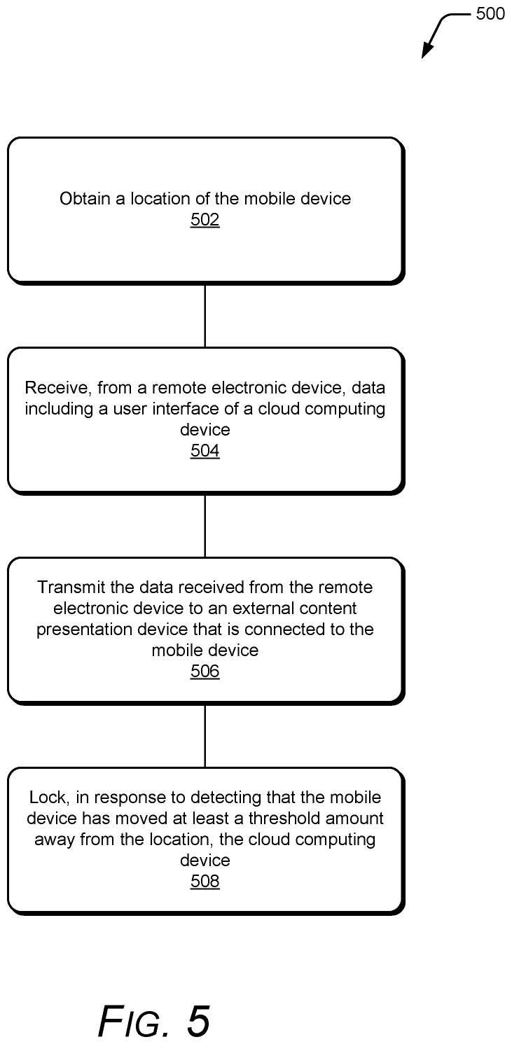

FIG. 5 illustrates an example process 500 for implementing the techniques discussed herein in accordance with one or more embodiments. Process 500 is carried out by a content streaming system, a communication system, or a combination thereof, such as content streaming system 214 and a communication system 212 of FIG. 1 or FIG. 2, and can be implemented in software, firmware, hardware, or combinations thereof. Process 500 is shown as a set of acts and is not limited to the order shown for performing the operations of the various acts.

In process 500, a location of a mobile device is obtained (act 502). The location of the mobile device can be automatically determined in response to various events as discussed above.

Data is received from a remote electronic device (act 504). This data is, for example, a computing device interface (e.g., a user interface) of a cloud computing device running on the remote electronic device.

The data received from the remote electronic device is transmitted to an external content presentation device that is connected to the mobile device (act 506). Accordingly, the mobile device acts as an intermediary between the remote electronic device and the external content presentation device.

In response to detecting that the mobile device has moved at least a threshold amount away from the location, the cloud computing device is locked (act 508). Accordingly, if the mobile device is moved at least a threshold amount away from the initial location of the mobile device (or of the external content presentation device), the data (e.g., computing device interface) is no longer displayed on the external content presentation device.

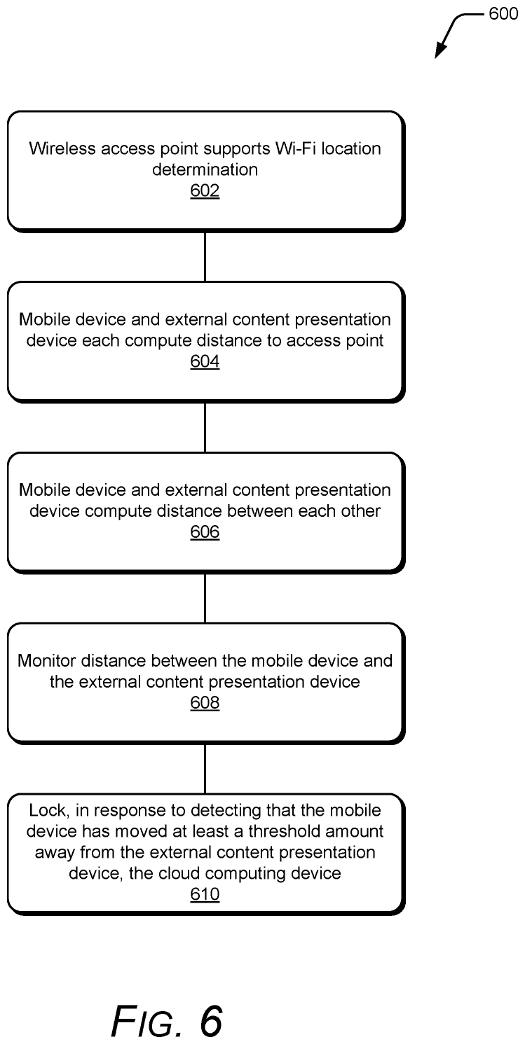

FIG. 6 illustrates an example process 600 for implementing the techniques discussed herein in accordance with one or more embodiments. Process 600 is carried out by a content streaming system, a communication system, or a combination thereof, such as content streaming system 214 and a communication system 212 of FIG. 1 or FIG. 2, and can be implemented in software, firmware, hardware, or combinations thereof. Process 600 is shown as a set of acts and is not limited to the order shown for performing the operations of the various acts.

In process 600, a determination is made that a wireless access point supports Wi-Fi location determination (act 602). This Wi-Fi location determination support is, for example, location coordinates (e.g., latitude, longitude, and altitude) that are fixed for the wireless access point. If the wireless access point is moved, the location coordinates for the wireless access point are reconfigured (e.g., manually).

A mobile device and an external content presentation device each compute their distance to the wireless access point (act 604). This distance is computed, for example using IEEE Wi-Fi RTT functionality, optionally with FTM functionality (e.g., using an IEEE 802.11mc standard). The mobile device and the external content presentation device may be connected to the same wireless access point (e.g., both connected to a wireless access point having the same basic service set identifier (BSSID)) or connected to different wireless access points (e.g., connected to wireless access points having different BSSIDs).

The relative distance between the mobile device and the external content presentation device is computed (act 606). This relative distance may be calculated by one or both of the mobile device and the external content presentation device. This relative distance is computed in any of various manners, such as using a multilateration technique (e.g., triangulation).

The distance between the mobile device and the external content presentation device is monitored (act 608). The distance between the mobile device and the external content presentation device is determined in response to any of various events, such as sensor data values (e.g., determining the distance is triggered in response to a displacement (e.g., indicated by an accelerometer or gyrometer) being detected). This distance is generated by calculating the distance between the wireless access point and the mobile device (e.g., using IEEE Wi-Fi RTT functionality with FTM functionality) and calculating the distance between the mobile device and the external content presentation device (e.g., using a multilateration technique), analogous to the discussion above in acts 604 and 606 (although the distances may be different due to the mobile device having moved).

In response to detecting that the mobile device has moved at least a threshold amount away from the external content presentation device, the cloud computing device is locked (act 610). Accordingly, if the mobile device is moved at least a threshold amount away from the external content presentation device, the data (e.g., computing device interface) is no longer displayed on the external content presentation device and inputs received from the external input device are ignored or deleted.

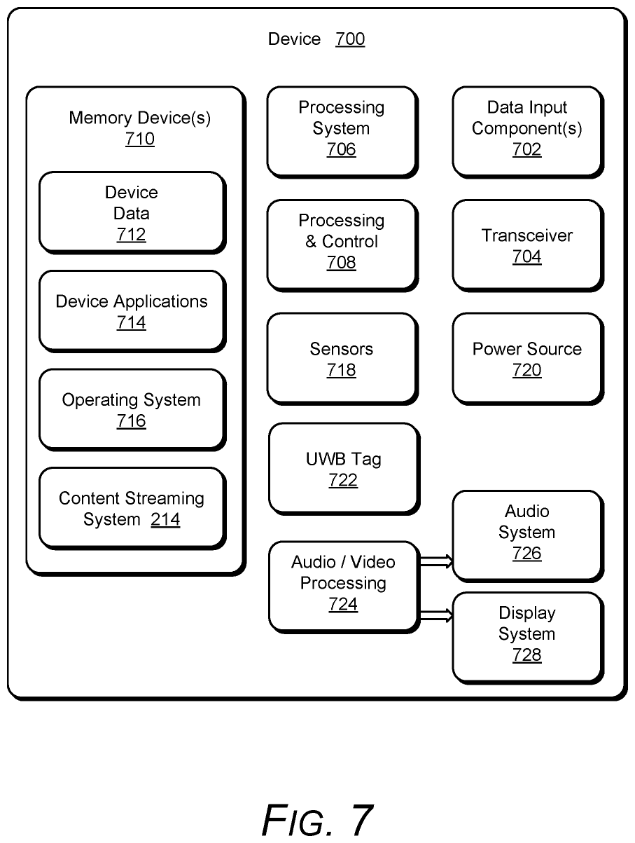

FIG. 7 illustrates various components of an example electronic device that can implement embodiments of the techniques discussed herein. The electronic device 700 can be implemented as any of the devices described with reference to the previous FIGS., such as any type of client device, mobile phone, tablet, computing, communication, entertainment, gaming, media playback, or other type of electronic device. In one or more embodiments the electronic device 700 the content streaming system 214, described above.

The electronic device 700 includes one or more data input components 702 via which any type of data, media content, or inputs can be received such as user-selectable inputs, messages, music, television content, recorded video content, and any other type of text, audio, video, or image data received from any content or data source. The data input components 702 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 702 may also include various other input components such as microphones, touch sensors, touchscreens, keyboards, and so forth.

The device 700 includes communication transceivers 704 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 700 includes a processing system 706 of one or more processors (e.g., any of microprocessors, controllers, and the like) or a processor and memory system implemented as a system-on-chip (SoC) that processes computer-executable instructions. The processing system 706 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 708. The device 700 may further include any type of a system bus or other data and command transfer system that couples the various components within the device. A system bus can include any one or combination of different bus structures and architectures, as well as control and data lines.

The device 700 also includes computer-readable storage memory devices 710 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 710 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory device 710 provides data storage mechanisms to store the device data 712, other types of information or data, and various device applications 714 (e.g., software applications). For example, an operating system 716 can be maintained as software instructions with a memory device and executed by the processing system 706 to cause the processing system 706 to perform various acts. The device applications 714 may also include a device manager, such as any form of a control application, software application, signal-processing and control module, code that is native to a particular device, a hardware abstraction layer for a particular device, and so on.

The device 700 can also include one or more device sensors 718, such as any one or more of an ambient light sensor, a proximity sensor, a touch sensor, an infrared (IR) sensor, accelerometer, gyroscope, thermal sensor, audio sensor (e.g., microphone), and the like. The device 700 can also include one or more power sources 720, such as when the device 700 is implemented as a mobile device. The power sources 720 may include a charging or power system, and can be implemented as a flexible strip battery, a rechargeable battery, a charged super-capacitor, or any other type of active or passive power source. The device 700 can also include one or more UWB tags 722.

The device 700 additionally includes an audio or video processing system 724 that generates one or both of audio data for an audio system 726 and display data for a display system 728. In accordance with some embodiments, the audio/video processing system 724 is configured to receive call audio data from the transceiver 704 and communicate the call audio data to the audio system 726 for play back at the device 700. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

Although embodiments of techniques for location based transmitting of data to an external content presentation device have been described in language specific to features or methods, the subject of the appended claims is not necessarily limited to the specific features or methods described. Rather, the specific features and methods are disclosed as example implementations of techniques for implementing location based transmitting of data to an external content presentation device. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a method implemented at a mobile device, the method including: obtaining a location of the mobile device: receiving, from a remote electronic device, data including a user interface of a cloud computing device: transmitting the data received from the remote electronic device to an external content presentation device that is connected to the mobile device; and locking, in response to detecting that the mobile device has moved at least a threshold amount away from the location, the cloud computing device.

In some aspects, the techniques described herein relate to a method, wherein the locking includes stopping, while the mobile device is connected to the external content presentation device, streaming data to the external content presentation device.

In some aspects, the techniques described herein relate to a method, wherein the locking comprises ignoring or deleting inputs received from an external input device associated with the external content presentation device.

In some aspects, the techniques described herein relate to a method, wherein obtaining the location of the mobile device includes using a Wi-Fi round-trip time (RTT) to measure a distance to each of multiple wireless devices.

In some aspects, the techniques described herein relate to a method, wherein obtaining the location of the mobile device includes using, based on one or more signals received from the multiple wireless devices, a multilateration technique to determine a location of the mobile device relative to the multiple wireless devices.

In some aspects, the techniques described herein relate to a method, wherein obtaining the location of the mobile device includes determining a distance of the mobile device from the external content presentation device using one or more ultra-wideband (UWB) signals.

In some aspects, the techniques described herein relate to a method, further including subsequent to locking the cloud computing device and in response to detecting that the mobile device has moved within the threshold amount of the location, unlocking the cloud computing device.

In some aspects, the techniques described herein relate to a method, further including monitoring, in response to movement of the mobile device, whether the mobile device has moved within the threshold amount of the location.

In some aspects, the techniques described herein relate to a method, wherein the mobile device includes a smartphone.

In some aspects, the techniques described herein relate to a mobile device, including: at least one memory; and at least one processor coupled with the at least one memory configured to cause the mobile device to: obtain a location of the mobile device: receive, from a remote electronic device, data including a user interface of a cloud computing device; transmit the data received from a remote electronic device to an external content presentation device that is connected to the mobile device; and lock, in response to detecting that the mobile device has moved at least a threshold amount away from the location, the cloud computing device.

In some aspects, the techniques described herein relate to a mobile device, wherein to lock the cloud computing device is to stop, while the mobile device is connected to the external content presentation device, streaming data to the external content presentation device.

In some aspects, the techniques described herein relate to a mobile device, wherein to lock the cloud computing device includes ignoring or deleting inputs received from an external input device associated with the external content presentation device.

In some aspects, the techniques described herein relate to a mobile device, wherein to obtain the location of the mobile device includes is to use a Wi-Fi round-trip time (RTT) to measure a distance to each of multiple wireless devices.

In some aspects, the techniques described herein relate to a mobile device, wherein to obtain the location of the mobile device is to use, based on one or more signals received from the multiple wireless devices, a multilateration technique to determine a location of the mobile device relative to the multiple wireless devices.

In some aspects, the techniques described herein relate to a mobile device, wherein to obtain the location of the mobile device is to determine a distance of the mobile device from the external content presentation device using one or more ultra-wideband (UWB) signals.

In some aspects, the techniques described herein relate to a mobile device, wherein the processor is configured to cause the mobile device to, subsequent to locking the cloud computing device and in response to detecting that the mobile device has moved within the threshold amount of the location, unlock the cloud computing device.

In some aspects, the techniques described herein relate to a mobile device, wherein the processor is configured to cause the mobile device to monitor, in response to movement of the mobile device, whether the mobile device has moved within the threshold amount of the location.

In some aspects, the techniques described herein relate to a mobile device, wherein the mobile device includes a smartphone.

In some aspects, the techniques described herein relate to a mobile device, including: a communication system, implemented at least in part in hardware, to receive data from a remote electronic device, the data including a user interface of a cloud computing device; and a content streaming system, implemented at least in part in hardware, to obtain a location of the mobile device, transmit the data received from the remote electronic device to an external content presentation device that is connected to the mobile device, and lock, in response to detecting that the mobile device has moved at least a threshold amount away from the location, the cloud computing device.

In some aspects, the techniques described herein relate to a mobile device, wherein the content streaming system is to resume, subsequent to stopping transmitting data to the external content presentation device and in response to detecting that the mobile device has moved within the threshold amount of the location, transmitting data received from the remote electronic device to the external content presentation.

What is claimed is:

1. A method implemented at a mobile device, the method comprising:
obtaining a location of the mobile device;
receiving, from a remote electronic device, data including a user interface of a cloud computing device;
transmitting the data received from the remote electronic device to an external content presentation device that is connected to the mobile device; and
locking, in response to detecting that the mobile device has moved at least a threshold amount away from the location, the cloud computing device.

2. The method of claim 1, wherein the locking comprises stopping, while the mobile device is connected to the external content presentation device, streaming data to the external content presentation device.

3. The method of claim 1, wherein the locking comprises ignoring or deleting inputs received from an external input device associated with the external content presentation device.

4. The method of claim 1, wherein obtaining the location of the mobile device comprises using a Wi-Fi round-trip time (RTT) to measure a distance to each of multiple wireless devices.

5. The method of claim 4, wherein obtaining the location of the mobile device comprises using, based on one or more signals received from the multiple wireless devices, a multilateration technique to determine a location of the mobile device relative to the multiple wireless devices.

6. The method of claim 1, wherein obtaining the location of the mobile device comprises determining a distance of the mobile device from the external content presentation device using one or more ultra-wideband (UWB) signals.

7. The method of claim 1, further comprising, subsequent to locking the cloud computing device and in response to detecting that the mobile device has moved within the threshold amount of the location, unlocking the cloud computing device.

8. The method of claim 1, further comprising monitoring, in response to movement of the mobile device, whether the mobile device has moved within the threshold amount of the location.

9. The method of claim 1, wherein the mobile device comprises a smartphone.

10. A mobile device, comprising:
at least one memory; and
at least one processor coupled with the at least one memory configured to cause the mobile device to:
obtain a location of the mobile device;
receive, from a remote electronic device, data including a user interface of a cloud computing device;
transmit the data received from a remote electronic device to an external content presentation device that is connected to the mobile device; and
lock, in response to detecting that the mobile device has moved at least a threshold amount away from the location, the cloud computing device.

11. The mobile device of claim 10, wherein to lock the cloud computing device is to stop, while the mobile device is connected to the external content presentation device, streaming data to the external content presentation device.

12. The mobile device of claim 10, wherein to lock the cloud computing device includes ignoring or deleting inputs received from an external input device associated with the external content presentation device.

13. The mobile device of claim 10, wherein to obtain the location of the mobile device comprises is to use a Wi-Fi round-trip time (RTT) to measure a distance to each of multiple wireless devices.

14. The mobile device of claim 13, wherein to obtain the location of the mobile device is to use, based on one or more signals received from the multiple wireless devices, a multilateration technique to determine a location of the mobile device relative to the multiple wireless devices.

15. The mobile device of claim 10, wherein to obtain the location of the mobile device is to determine a distance of the mobile device from the external content presentation device using one or more ultra-wideband (UWB) signals.

16. The mobile device of claim 10, wherein the processor is configured to cause the mobile device to, subsequent to locking the cloud computing device and in response to detecting that the mobile device has moved within the threshold amount of the location, unlock the cloud computing device.

17. The mobile device of claim 10, wherein the processor is configured to cause the mobile device to monitor, in response to movement of the mobile device, whether the mobile device has moved within the threshold amount of the location.

18. The mobile device of claim 10, wherein the mobile device comprises a smartphone.

19. A mobile device, comprising:
a communication system, implemented at least in part in hardware, to receive data from a remote electronic device, the data including a user interface of a cloud computing device; and
a content streaming system, implemented at least in part in hardware, to obtain a location of the mobile device, transmit the data received from the remote electronic device to an external content presentation device that is connected to the mobile device, and lock, in response to detecting that the mobile device has moved at least a threshold amount away from the location, the cloud computing device.

20. The mobile device of claim 19, wherein the content streaming system is to unlock, subsequent to locking the cloud computing device and in response to detecting that the mobile device has moved within the threshold amount of the location, the cloud computing device.
